(19) United States
(12) Patent Application Publication
(10) Pub. No.: US 2026/0366943 A1
(43) Pub. Date: Nov. 19, 2026

(54) SYSTEM FOR DETECTING LEAKS OF CONTAINERS

(71) Applicant: FT SYSTEM SRL, Alseno (PC) (IT)

(72) Inventor: Fabio FORESTELLI, Alseno (PC) (IT)

(21) Appl. No.: 19/487,695

(22) PCT Filed: May 24, 2024
(86) PCT No.: PCT/IB2024/055058

§ 371 Date: Nov. 25, 2025

(30) Foreign Application Priority Data
May 26, 2023 (IT) 102023000010728

(51) Int. Cl. G01M 3/04

(52) U.S. Cl. CPC G01M 3/04

(57) ABSTRACT

A system for detecting leaks of sealed containers includes a conveyor belt arranged to transport containers, a pressing system configured to apply a compressive mechanical load to the containers by pressing them against the conveyor belt, a suction and measurement system comprising suction units configured to suck gases from areas adjacent to the containers under compression and a sensor for measuring the concentration of one or more gases among the sucked gases, and a processing unit configured to compare the gas concentration with a reference gas concentration to determine whether the tested container is leaking. The pressing system comprises a plurality of rollers associated with movement members controlled by a control unit. The movement members comprise height translation members configured to move the rollers in a vertical direction, each roller independently of the other rollers and so that the rollers in their movement follow the shape of the tested container.

### TECHNICAL FIELD

The present invention relates to a system for detecting leaks of containers, said system being configured to detect leaks in sealed containers, more particularly in food containers used for packaging in a protective atmosphere.

### BACKGROUND ART

Detecting leaks in sealed food containers used for packaging in a protective atmosphere typically comprises the following steps:
a) Applying a mechanical stress to a sealed container, by means of a squeezing technique, in order to promote exit of gases from inside the container towards the outside, in case there is a leak.
Said mechanical stress is necessary because the internal pressure in food containers is typically equal to atmospheric pressure.
b) Measuring, by means of one or more gas sensors, the concentration of one or more gases in the outer environment in the immediate vicinity of the container.

The aim of this step is to detect exit of a gas from the container, which gas, being part of the gas mixture forming the protective atmosphere inside the container, is usually present inside the containers at much higher concentrations than the usual concentration of the same gas outside the container.

The region that is usually inspected is the whole outer lateral surface of the container, where there might be micro-leaks.

In addition, optionally, the lower part of the container is also inspected, by using an extractor hood that draws off the gas present in the area adjacent to the lower part of the container and conveys it to a measuring zone, where a gas sensor performs the measurement of the concentration.

Where the containers are trays, the inspection is typically limited to the upper part of the tray and, particularly, to the welded regions between the tray and a film sealing the tray.
c) Comparing the measured concentration of gas with a reference concentration of gas, measured for a leak-free container, to determine whether the inspected container is leaking.

The known systems for leak detection that perform the aforesaid functions are usually uncapable of applying an appropriate pressure to the containers such as to cause the exit of gases from the container without however damaging the container.

For example, document US2022228944A1, in the name of the Applicant, describes a leak detection system which performs said functions and in which the mechanical stress is applied to the containers by means of a pair of rotatable rollers, each of said rotatable rollers being suspended from a corresponding floating arm hinged to a hinge axis of its own and connected to a corresponding pneumatic cylinder capable of applying a certain pressure to the respective arm and, consequently, to the roller suspended therefrom. The pneumatic cylinders therefore operate in a passive manner, whereby the rollers move in height displaced by a container passing underneath them. The assembly consisting of an arm, the corresponding pneumatic cylinder and the roller associated with said arm defines as a whole a third-class lever, whereby the movement of each roller in height is of the type pivoting around the hinge axis of the respective floating arm. In particular, a first roller, when encountered by a container, performs a pivoting upward movement in a counterclockwise direction, and a second roller, when encountered by a container, performs a pivoting upward movement in a clockwise direction. Said movements of the rollers often result in the jamming of the containers, not only because of the vertical rotation of the rollers, but also because of the pivoting upward movement of the second roller in the clockwise direction.

The object of the present invention is to overcome the limitations of prior art by providing a leak detection system capable of adequately pressing the containers in such a way as to improve measurement sensitivity, i.e. the capability of detecting smaller leaks than in prior art.

A further object of the invention is to provide a leak detection system that can adapt to a wide variety of containers.

These and other objects are achieved with the detection system as claimed in the appended claims.

### SUMMARY OF INVENTION

The system for detecting leaks of sealed containers according to the invention comprises:
a conveyor belt, arranged to transport containers along a forward direction;
a pressing system, configured to apply a compressive mechanical load (squeezing) to the containers by pressing them against the conveyor belt;
a suction and measurement system, comprising suction units configured to suck gases from areas adjacent to the containers under compression and one or more sensors for measuring the concentration of one or more gases among the sucked gases;
a processing unit, configured to compare the gas concentration measured by the suction and measurement system with a reference gas concentration, in order to determine whether the tested container is leaking.

Preferably, the leak detection system according to the invention is a system included in a container-conveying line, i.e. it is a so-called “inline” detection system.

The pressing system comprises a plurality of rollers (two or more, preferably four, rollers) associated with movement members controlled by a control unit.

The movement members comprise height translation members configured to move the rollers in a vertical direction, each roller independently of the other rollers and so that the rollers in their movement follow the shape of the tested container, exerting the maximum pressure applicable to the container without damaging it. These height translation members comprise, for example, a set of pistons, one for each roller.

According to the invention, the movement of the rollers therefore has a wave-like pattern: when a container passes through the detection system, the rollers lift and lower, pressing the container and adapting to the shape of the container. In this way, the container and the food content inside the container do not get damaged.

The rollers of the pressing system have axes of rotation (coincident with their longitudinal axes) parallel to the conveyor belt and perpendicular to the forward direction of the conveyor belt and are arranged aligned one after the other along said forward direction of the conveyor belt.

Preferably, the movement members of the pressing system are configured to drive the rollers to rotate in accordance with the conveyor belt and in such a way that the rollers have a peripheral speed equal to the forward speed of the conveyor belt. The rotation of the rollers with a peripheral speed equal to the forward speed of the conveyor belt makes it possible to prevent damage to the containers, especially to the sealing films of containers made as trays.

The pistons of the height translation members operate, for example, in an active manner and activation thereof, which causes the upward or downward movement of the rollers, is controlled by the passage of a container on the conveyor belt, which passage is detected by a photocell and an encoder of the conveyor belt.

Alternatively, the pistons of the height translation members operate in a passive manner, being preloaded with a predetermined force.

Preferably, the plurality of suction units of the suction and measurement system comprises at least one upper suction unit, at least one first lateral suction unit and at least one second lateral suction unit.

The upper suction unit is arranged between two rollers of said plurality of rollers and is mounted so as to move in height integrally with one of the rollers, whereby the distance between suction ports of the upper suction unit and the tested container passing in the proximity of the upper suction units is minimized.

The first lateral suction unit and the second lateral suction unit are arranged laterally with respect to the rollers, on opposite sides, and are fixedly mounted at a certain height and distance from the rollers, said height and distance being selected according to the container to be tested, so that the distance between the suction ports of the lateral suction units and the tested container passing in the proximity of the lateral suction units is minimized.

Optionally, the conveyor belt comprises a first section and a second section, placed consecutively to each other and spaced apart from each other. In this case, preferably, the suction and measurement system comprises at least one lower suction unit, arranged between the first section and the second section of the conveyor belt, flush with the surface of the conveyor belt on which the containers are placed, whereby suction ports of the lower suction unit are in contact with the tested container at the time when the container passes from the first section to the second section of the conveyor belt.

### BRIEF DESCRIPTION OF DRAWINGS

These and other features and advantages of the present invention will become evident from the following description of preferred embodiments given by way of non-limiting examples with reference to the annexed figures, in which parts indicated with same or similar reference numerals indicate parts with same or similar function and construction, and in which:

FIG. 1 shows a perspective view of a system for detecting leaks of containers according to the invention;

FIG. 2 shows a side view of the system for detecting leaks of containers of FIG. 1;

FIGS. 3a-3g show schematic views of the system for detecting leaks of containers at different steps of a first operation mode;

FIGS. 4a-4d show schematic views of the system for detecting leaks of containers at different steps of a second operation mode.

### DESCRIPTION OF EMBODIMENTS

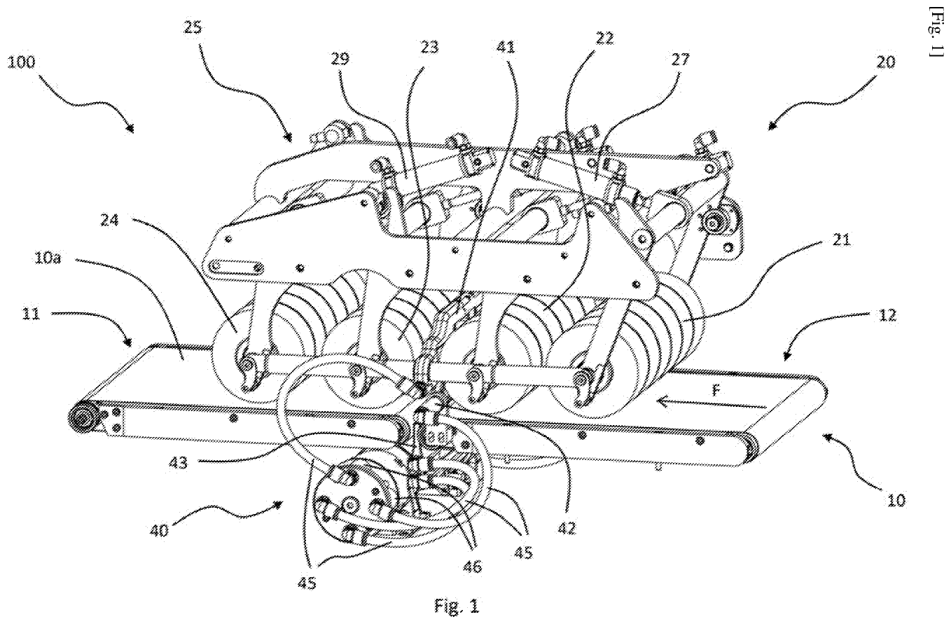

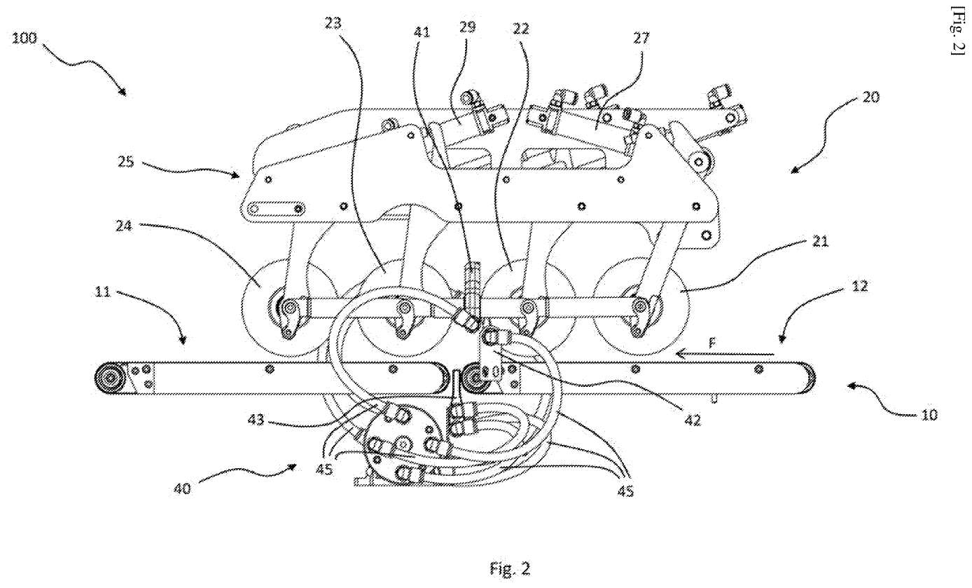

A leak detection system 100 for sealed containers, particularly food containers, according to an embodiment of the present invention is described below with reference to FIGS. 1 and 2.

The leak detection system 100 comprises:
a conveyor belt 10, arranged to transport the containers, said conveyor belt comprising a first section 11 and a second section 12, placed consecutively to each other and spaced apart from each other;
a pressing system 20, configured to apply a compressive mechanical load (squeezing) to the containers by pressing them against the conveyor belt 10;
a suction and measurement system 40, configured to suck gases from areas adjacent to the containers under compression and for measuring the concentration of one or more gases among the sucked gases;
a processing unit (not shown), configured to compare the gas concentration measured by the suction and measurement system 40 with a reference gas concentration, in order to determine whether the tested container is leaking.

The pressing system 20 comprises four rollers—i.e. a first roller 21, a second roller 22, a third roller 23 and a fourth roller 24—associated to movement members 25 controlled by a control unit (not shown).

The rollers 21-24 have axes of rotation (coincident with the longitudinal axes of the rollers) parallel to the conveyor belt 10 and perpendicular to the forward direction F of the conveyor belt 10 and are arranged aligned one after the other along said forward direction F.

The movement members 25 comprise rotation members, for example belts (not shown), configured to drive the rollers 21-24 to rotate in accordance with the conveyor belt (in the figures, the forward direction F of the conveyor belt 10 is from right to left and therefore the rollers 21-24 rotate in a clockwise direction). Also, the rotation members are configured to drive the rollers 21-24 in such a way that said rollers preferably have a peripheral speed (i.e. the tangential speed) equal to the forward speed of the conveyor belt 10.

The movement members 25 further comprise height translation members configured to move the rollers 21-24 in a vertical direction, each independently of the others. In particular, the height translation members comprise a first piston 27 associated with the first roller 21, a second piston (not shown in FIGS. 1 and 2) associated with the second roller 22, a third piston 29 associated with the third roller 23, and a fourth piston (not visible in FIGS. 1 and 2) associated with the fourth roller 24.

Thanks to the independent movement of the rollers 21-24, the rollers 21-24 are moved in height so as to follow the shape of the tested container, exerting the maximum pressure applicable to the container without damaging it. The movement of the four rollers 21-24 therefore has a wave-like pattern: when a container passes through the detection system 10, the rollers 21-24 lift and lower, pressing the container and adapting to the shape of the container. In this way, the container and the food content inside the container do not get damaged. In addition, the rotation of the rollers 21-24 at a peripheral speed equal to the forward speed of the conveyor belt 10 makes it possible to prevent damage to the containers, especially to the sealing films of containers made as trays.

The pressing system 20 is thus capable of adapting to test containers of different size, shape and hardness, such as small and large bags, trays, tray-containing bags, flat containers (such as packages for the so-called “piadine”), trays sealed with plastic laminated paper films, plastic films or thermoformed films, etc.

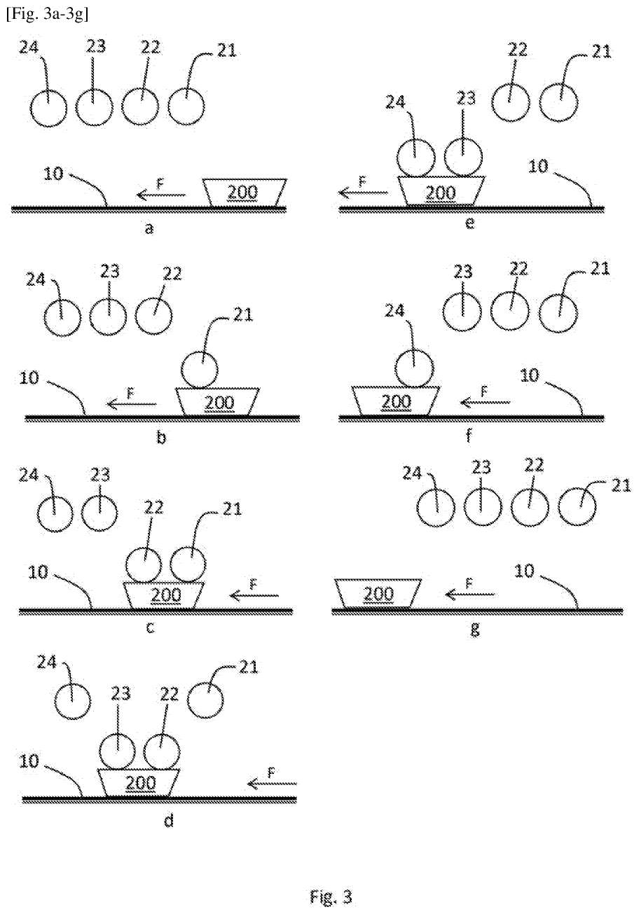

According to a first embodiment, the pistons 27, 29 of the height translation members operate in an active mode and activation thereof, which causes the upward or downward movement of the rollers 21-24, is controlled by the passage of a container 200 on the conveyor belt 10, which passage is detected by a photocell and an encoder of the conveyor belt 10. In this operation mode, therefore, the rollers 21-24 start from a starting position in which they are at a height, in relation to the conveyor belt 10, greater than the height of the containers 200 to be tested, and they lower according to the forward movement of the container 200 on the conveyor belt 10, until the rollers reach a height suitable to press the container 200 with the maximum applicable force without it getting damaged. The height of the rollers in the starting position and the height of the rollers in the lowered position are set according to the shape and size of the container to be tested. This operation mode of the pistons 27, 29 is particularly advantageous in case of containers made as trays sealed at the top by a sealing film. In such cases, in fact, the control unit of the pressing system 20 is configured to drive the pistons 27, 29 in such a way that the rollers 21-24 only impact the top of the tray 200 and not the front or rear parts thereof, where pressing by the roller could cause damage to the tray (in particular, to the welding between the film and the tray). Said operation mode of the leak detection system 10 is schematically shown in FIGS. 3a-g, where the forward movement of the container 200 takes place from right to left.

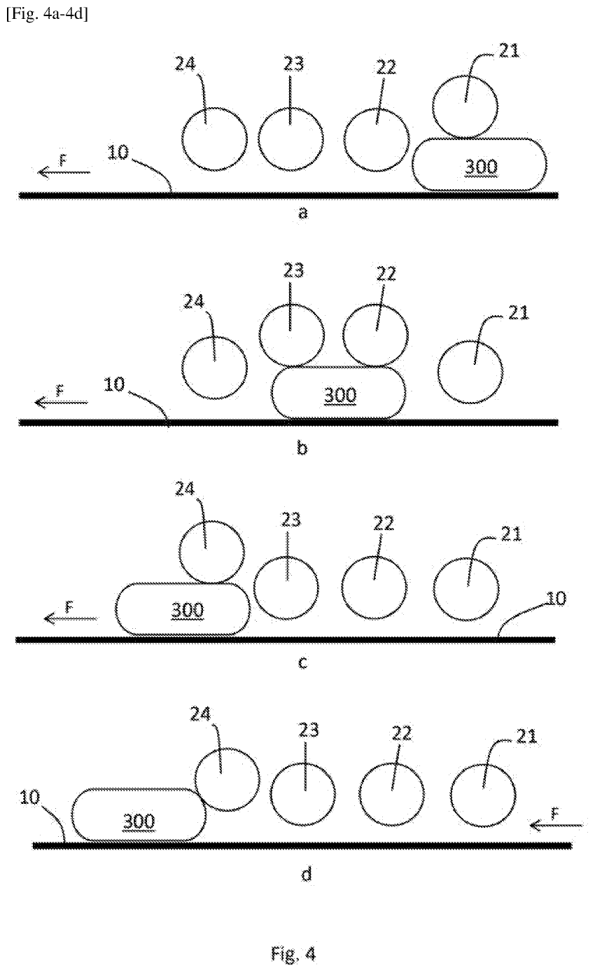

According to a further embodiment, the pistons 27, 29 of the height translation members operate in a passive mode, being preloaded with a predetermined force. In this configuration, the rollers 21-24 start from a starting position in which they are at a height, in relation to the conveyor belt 10, lower than the height of the container 300, so that, upon passage of the container 300, each roller 21-24 exerts a certain pressure on the container (by virtue of the preloading force of the respective roller) and performs, displaced as a result of the resistance offered by the container 300, an upward translation movement and then, pushed by the respective piston, returns downwards. The height of the rollers in the starting position is set according to the shape and size of the container to be tested. Furthermore, in this operation mode, the adjustment on the pistons only serves to determine the pressing force, whereas the lifting/lowering instant is determined by the interaction between the container 300 and the rollers 21-24. This operation mode of the leak detection system 10 is schematically shown in FIGS. 4a-d, where the forward movement of the container 200 takes place from right to left.

The suction and measurement system 40 comprises a plurality of suction units, namely an upper suction unit 41, a first lateral suction unit 42 and second lateral suction unit (not visible in FIGS. 1 and 2), and a lower suction unit 43.

The upper suction unit 41 is arranged between the second roller 22 and the third roller 23 and preferably comprises a plurality of suction ports (not visible in the Figures) facing downwards. The upper suction unit 41 is mounted so as to move in height integrally with one of the rollers, for example, the second roller 22, so that the distance between its suction ports and the tested container passing in the proximity of the upper suction unit 41 is minimized (for example, it is less than five millimeters). The upper suction unit 41 can extend substantially over the entire length of the rollers. Alternatively, a plurality of upper suction units 41 can be provided, arranged one after the other along the direction parallel to the longitudinal axes of the rollers, preferably in such a way as to substantially cover the entire length of the rollers.

The first lateral suction unit 42 and the second lateral suction unit are arranged laterally with respect to the rollers 21-25; in particular, the first lateral suction unit 42 is arranged at a first side of the rollers 21-24 and the second lateral suction unit is arranged at a second side, opposite to the first side, of the rollers 21-24. Both lateral suction units are positioned so that they appear, when the system is viewed from the side, between the second roller 22 and the third roller 23. Each lateral suction unit has one or more suction ports (not visible in the Figures) facing towards the rollers 21-24. The lateral suction units are fixedly mounted at a certain height and distance from the rollers, said height and distance being selected according to the container to be tested, so that the distance between suction ports of the lateral suction units and the tested container passing in the proximity of the lateral suction units is minimized.

The lower suction unit 43 is arranged between the first section 11 and the second section 12 of the conveyor belt 10 and comprises a plurality of suction ports (not visible in the Figures) facing upwards. Preferably, the lower suction unit 43 is arranged flush with the surface 10a of the conveyor belt 10 on which the containers are placed, whereby its suction ports are in contact with the tested container at the time when the container passes from the first section 11 to the second section 12 of the conveyor belt 10. The lower suction unit 43 preferably extends substantially over the entire length of the rollers 21-24. The presence of the lower suction unit 43 makes it possible to suck gases also from the zone under the tested container, thereby making it possible to detect leaks present at the bottom of the container.

The suction and measurement system 40 comprises gas sensors, connected to the suction units by means of appropriate ducts 45, so that the sucked gas can reach said sensors 46 to measure the concentration of one or more gases. In particular, the sensors 46 measure the concentration of gases in the gas mixture forming the protective atmosphere present inside the container, said gases in said protective atmosphere being present in concentrations much higher than their concentrations in the environment outside the container. In general, a plurality of sensors can be used to measure the concentration of a single gas; in fact, the more sensors are used, the more accurate the measurement of the concentration of a gas is. In addition, a single sensor can be configured to measure the concentration of several different gases. Preferably, the sensors 46 are arranged under the conveyor belt 10.

1. A system for detecting leaks (100) of sealed containers comprising:
a conveyor belt (10), arranged to transport containers along a forward direction (F);
a pressing system (20), configured to apply a compressive mechanical load to the containers by pressing them against the conveyor belt (10);
a suction and measurement system (40), comprising suction units (41, 42, 43) configured to suck gases from areas adjacent to the containers under compression and one or more sensors for measuring the concentration of one or more gases among the sucked gases; and
a processing unit, configured to compare the gas concentration measured by the suction and measurement system (40) with a reference gas concentration, in order to determine whether the tested container is leaking,
wherein the pressing system (20) comprises a plurality of rollers (21, 22, 23, 24) associated with movement members (25) controlled by a control unit, and
wherein the movement members (25) comprise height translation members configured to move the rollers (21, 22, 23, 24) in a vertical direction, each roller independently of the other rollers and so that the rollers in their movement follow the shape of the tested container.

2. The system according to claim 1, wherein the rollers (21, 22, 23, 24) have axes of rotation parallel to the conveyor belt (10) and perpendicular to the forward direction (F) of the conveyor belt (10) and are arranged aligned one after the other along said forward direction (F).

3. The system according to claim 1, wherein said plurality of rollers consists of a first roller (21), a second roller (22), a third roller (23) and a fourth roller (24).

4. The system according to claim 1, wherein the movement members (25) are further configured to drive the rollers (21, 22, 23, 24) to rotate in accordance with the conveyor belt (10) and so that the rollers (21, 22, 23, 24) have a peripheral speed equal to the forward speed of the conveyor belt (10).

5. The system according to claim 1, wherein the height translation members comprise pistons (27, 29) which operate in an active mode and their activation, which causes the upward or downward movement of the rollers (21, 22, 23, 24), is controlled by the passage of a container on the conveyor belt (10), which passage is detected by a photocell and an encoder of the conveyor belt (10).

6. The system according to claim 5, wherein the rollers (21, 22, 23, 24) start from a starting position in which they are at a height, in relation to the conveyor belt (10), greater than the height of the containers (200) to be tested, and they lower as the container (200) moves forward on the conveyor belt (10), until the rollers reach a height suitable to press the container (200) with the maximum applicable force without it getting damaged.

7. The system according to claim 6, wherein the control unit of the pressing system (20) is configured to drive the pistons (27, 29) in such a way that the rollers (21, 22, 23, 24) only impact the top of a container (200) and not the front or rear parts thereof.

8. The system according to 4 claim 1, wherein the height translation members comprise pistons (27, 29) which operate in a passive mode, being preloaded with a predetermined force.

9. The system according to claim 1, wherein the suction units of the suction and measurement system (40) comprise at least one upper suction unit (41), and wherein said at least one upper suction unit (41) is arranged between two rollers (22, 23) of said plurality of rollers (21, 22, 23, 24) and is mounted so as to move in height integrally with one (22) of the rollers.

10. The system according to claim 1, wherein the suction units of the suction and measurement system (40) comprise at least one first lateral suction unit and at least one second lateral suction unit, wherein said at least one first lateral suction unit (42) and said at least one second lateral suction unit are arranged laterally with respect to the rollers (21, 22, 23, 24), on opposite sides, and are fixedly mounted at a certain height and distance from the rollers.

11. The system according to claim 1, wherein the conveyor belt (10) comprises a first section (11) and a second section (12), placed consecutively to each other and spaced apart from each other.

12. The system according to claim 11, wherein the suction units of the suction and measurement system (40) further comprise at least one lower suction unit (43) arranged between the first section (11) and the second section (12) of the conveyor belt (10), flush with the surface (10a) of the conveyor belt (10) on which the containers are placed.

13. The system according to claim 3, wherein the height translation members comprise pistons (27, 29) which operate in an active mode and their activation, which causes the upward or downward movement of the rollers (21, 22, 23, 24), is controlled by the passage of a container on the conveyor belt (10), which passage is detected by a photocell and an encoder of the conveyor belt (10).

14. The system according to claim 13, wherein the rollers (21, 22, 23, 24) start from a starting position in which they are at a height, in relation to the conveyor belt (10), greater than the height of the containers (200) to be tested, and they lower as the container (200) moves forward on the conveyor belt (10), until the rollers reach a height suitable to press the container (200) with the maximum applicable force without it getting damaged.

15. The system according to claim 14, wherein the control unit of the pressing system (20) is configured to drive the pistons (27, 29) in such a way that the rollers (21, 22, 23, 24) only impact the top of a container (200) and not the front or rear parts thereof.

16. The system according to claim 2, wherein the suction units of the suction and measurement system (40) comprise at least one upper suction unit (41), and wherein said at least one upper suction unit (41) is arranged between two rollers (22, 23) of said plurality of rollers (21, 22, 23, 24) and is mounted so as to move in height integrally with one (22) of the rollers.

17. The system according to claim 3, wherein the suction units of the suction and measurement system (40) comprise at least one upper suction unit (41), and wherein said at least one upper suction unit (41) is arranged between two rollers (22, 23) of said plurality of rollers (21, 22, 23, 24) and is mounted so as to move in height integrally with one (22) of the rollers.

18. The system according to claim 2, wherein the suction units of the suction and measurement system (40) comprise at least one first lateral suction unit (42) and at least one second lateral suction unit, wherein said at least one first lateral suction unit (42) and said at least one second lateral suction unit are arranged laterally with respect to the rollers (21, 22, 23, 24), on opposite sides, and are fixedly mounted at a certain height and distance from the rollers.

19. The system according to claim 3, wherein the suction units of the suction and measurement system (40) comprise at least one first lateral suction unit (42) and at least one second lateral suction unit, wherein said at least one first lateral suction unit (42) and said at least one second lateral suction unit are arranged laterally with respect to the rollers (21, 22, 23, 24), on opposite sides, and are fixedly mounted at a certain height and distance from the rollers.

20. The system according to claim 9, wherein the suction units of the suction and measurement system (40) comprise at least one first lateral suction unit (42) and at least one second lateral suction unit, wherein said at least one first lateral suction unit (42) and said at least one second lateral suction unit are arranged laterally with respect to the rollers (21, 22, 23, 24), on opposite sides, and are fixedly mounted at a certain height and distance from the rollers.
